(19) United States
(12) Patent Application Publication
(10) Pub. No.: US 2004/0130674 A1
(43) Pub. Date: Jul. 8, 2004

(54) Monocular eyeglass assembly

(76) Inventor: Joyce G. Epstein, Manchester, CT (US)

Correspondence Address: Victor E Libert, Libert & Associates, 3 Mill Pond Lane, PO Box 538, Simsbury, CT, 06070-0538, US

(21) Appl. No.: 10/250,646

(22) PCT Filed: Mar. 26, 2002
(86) PCT No.: PCT/US02/09301

(51) Int. Cl. G02C 1/00; G02C 5/20

(52) U.S. Cl. 351/115

(57) ABSTRACT

A monocular eyeglass assembly (10) is suitable for use in applying substances to one eye or areas surrounding one eye while enjoying lens-corrected vision in the other eye. The assembly (10) includes a single temple (16) coupled to a frame (14) holding a lens (12) and a nose bridge (20) coupled to the frame. The assembly (10) enables the lens (12) to be positioned in alignment with one of the weare's eyes while allowing the wearer's other eye and its surrounding area to remain completely unobstructed by the assembly (10).

### RELATED APPLICATION

This application claims priority of provisional patent application Serial No. 60/279,362 of Joyce Epstein, filed Mar. 28, 2001 and entitled “Monocular Eyeglass”.

### FIELD OF THE INVENTION

The present invention relates generally to eyeglass frames, and more particularly relates to monocular eyeglass frames which are particularly useful in aiding vision in one eye while applying substances, such as makeup or medications, to the other eye or to areas immediately around the other eye.

### RELATED ART

Applying eye makeup, administering eye medications, tweezing or otherwise treating eyebrows, and self-examination of the eye and immediately surrounding area are often difficult for individuals who wear prescription lenses. If left in place, the eyeglasses interfere with access to the eye area. If removed, vision is impaired, which may result in misapplication of medication or makeup or, more seriously, injury to the eye. The art has proposed solutions to address this situation.

For example, U.S. Pat. No. 5,561,481 to Dileo et al discloses a frame assembly including a single lens that rotates between a position in optical registry with the wearer's left eye and another position in optical registry with the wearer's right eye. The frame assembly comprises a support including a left eye frame and a right eye frame, and two arms, one arm coupled to the left eye frame and another arm coupled to the right eye frame, and a lens rotatably coupled to the support. While Dileo et al does remove some of the interference encountered from lens or frame components, the devices disclosed therein still leave the area of the unlensed eye at least partially obstructed by the eye frame.

U.S. Pat. No. 3,840,294 to Kneier discloses makeup glasses comprised of a bridge, two lens frames and two arms connected, respectively, to the lens frames. The lenses are connected so as to permit rotational or transverse movement of the lens, as well as lateral shifting thereof to expose the eye being ministered to. An arrangement is provided to enable the bridge and the lenses supported thereon to be moved upwardly and downwardly to position the bridge higher or lower of the wearer's nose.

Other devices which generally operate on the principle of moving one or both lenses to facilitate application of makeup, medication or the like are shown in U.S. Pat. No. 4,373,789 to Roberts, U.S. Pat. No. 4,405,213 to Kolkmann, U.S. Pat; No. 4,880,302 to Meillet, U.S. Pat. No. 773,750 to Kay and U.S. Pat. No. 3,495,898 to Del Vecchio.

### SUMMARY OF THE INVENTION

Generally, the present invention provides a monocular eyeglass assembly comprised of a single lens frame, a single support arm (“temple”) and a nose bridge coupled to the lens frame, wherein the temple and nose bridge cooperate to secure the assembly to the wearer's face with a lens positioned in optical registry (i.e., aligned) with one eye while the other eye and its surrounding eye area are entirely unobstructed.

In the various embodiments, the single temple and nose bridge are dimensioned and configured to, or are adjustable to, enable the lens to be selectively positioned in optical alignment with either the left or right eye of the wearer.

Specifically, in accordance with the present invention there is provided a monocular eyeglass assembly comprising the following components. The assembly has only one lens, the lens having a temple side and a laterally opposite bridge side; only one temple, the temple having a distal end and an opposite proximal end, the proximal end of the temple being attached to the lens at the temple side thereof; and a nose bridge attached to the lens at the bridge side thereof. The assembly is dimensioned and configured so that when the lens is disposed in alignment with one eye of the wearer, the wearer's other eye and its surrounding area are unobstructed by the assembly.

One aspect of the invention provides for the distal end of the temple to be dimensioned and configured to be supported by either a wearer's left ear or right ear, thereby enabling the lens to be selectively positioned in alignment with either of the wearer's left eye or right eye, according to the ear on which the ear piece is supported.

Another aspect of the present invention provides that the distal end of the temple terminates in a pair of oppositely curved ear pieces, one of which is dimensioned and configured to be supported on the wearer's left ear and the other of which is dimensioned and configured to be supported on the wearer's right ear.

Other aspects of the present invention provide one or more of the following features, alone or in combination of two or more thereof. The assembly may further comprise a lens frame connecting the proximal end of the temple to the nose bridge and the lens is removably mounted, whereby to enable the wearer to replace one lens with another; the nose bridge may have a top pad structure and an opposite-facing bottom pad structure, each of which is dimensioned and configured so as to rest upon the wearer's nose to support the bridge side of the lens; and the nose bridge may have a pad structure and be movable relative to the lens whereby the pad structure is selectively positionable to rest upon the wearer's nose when the ear piece is positioned to be supported on either the wearer's right ear or left ear.

Another aspect of the present invention provides a monocular eyeglass assembly comprising the following components. The assembly has only one lens, the lens having a first side on which is disposed a first-side connector and a laterally opposite second side on which is disposed a second-side connector; only one temple, the temple having a distal end and an opposite proximal end, the proximal end having a temple connector thereon; and a nose bridge attached to the lens at the bridge side thereof. The nose bridge has at least one bridge connector thereon. The connectors all being dimensioned and configured whereby both the proximal end of the temple and the nose bridge may be connected to either the first-side connector or the second-side connector of the lens, thereby configuring the assembly to selectively place the lens in alignment with either a wearer's left eye or right eye, the assembly being dimensioned and configured so that when the lens is disposed in alignment with one eye of the wearer, the wearer's other eye and its surrounding area are unobstructed by the assembly.

In a related aspect, the present invention provides for the nose bridge to have a pair of laterally opposite bridge connectors, one of which is dimensioned and configured to connect the nose bridge to the first-side connector and the other of which is dimensioned and configured to connect the nose bridge to the second-side connector.

The present invention also provides a kit for a monocular eyeglass assembly. The kit comprises a plurality of lenses each having a temple side and a laterally opposite bridge side, a temple connector at the temple side and a bridge connector at the bridge side; at least one temple having a distal end and an opposite proximal end and a temple connector at the proximal end; and at least one nose bridge having at least one nose connector thereon. The connectors are dimensioned and configured to enable the temple and the nose bridge to be connected to a selected one of each of the plurality of lenses to provide an assembly which is dimensioned and configured to enable at least one of the lenses to be aligned with a wearer's left eye and at least another of the lenses to be aligned with a wearer's right eye, the assembly being dimensioned and configured so that when the lens is disposed in alignment with one eye of the wearer, the wearer's other eye and its surrounding area are unobstructed by the assembly.

The kit aspect of the present invention also provides an aspect wherein the nose bridge has a pair of laterally opposite connectors, one of which is dimensioned and configured to connect the nose bridge to the bridge connector of at least one of the plurality of lenses and the other of which is dimensioned and configured to connect the nose bridge to the bridge connector of at least another one of the plurality of lenses.

Yet another aspect of the kit of the present invention resides in a kit for a monocular eyeglass assembly comprising a plurality of lenses, e.g., two, each having a temple side and a laterally opposite bridge side, a temple connector at the temple side and a nose bridge mounted at the bridge side, at least one of the plurality of lens being dimensioned and configured to comprise a right eye lens and at least another of the plurality of lenses being dimensioned and configured to comprise a left-eye lens. The kit further comprises at least one temple having a distal end and an opposite proximal end and a temple connector at the proximal end. The connectors are dimensioned and configured to enable the temple to be connected to a selected one of each of the plurality of lenses at the temple side thereof to provide an assembly which is dimensioned and configured (i) to enable at least one of the lenses to be aligned with a wearer's left eye and at least another of the lenses to be aligned with a wearer's right eye, depending on whether the lens is a right-eye lens or a left-eye lens, and (ii) so that when the lens is disposed in alignment with one eye of the wearer, the wearer's other eye and its surrounding area are unobstructed by the assembly.

Other aspects of the kit of the present invention provide that the plurality of lenses comprises at least one lens having optical characteristics suitable for a wearer's left eye and at least one lens having optical characteristics suitable for the wearer's right eye; the lenses may bear indicia to signify whether they are for a wearer's left eye or right eye.

### BRIEF DESCRIPTION OF THE DRAWINGS

FIG. 1 is a front perspective front view of a left eyeglass frame assembly in accordance with one embodiment of the present invention;

FIG. 2 is a front perspective view of a right eyeglass frame assembly in accordance with another embodiment of the present invention;

FIG. 3 is a front perspective view of a third embodiment of the present invention comprising an eyeglass frame assembly having a single temple ending in oppositely curved ear pieces and a pivoting nose bridge;

FIG. 4 is a front perspective view of a fourth embodiment of the present invention comprising an eyeglass frame assembly having a pivoting single temple and a pivoting nose bridge;

FIG. 5 is a front perspective view of a fifth embodiment of the present invention comprising an eyeglass frame assembly having a single temple ending in oppositely curved ear pieces and a pair of oppositely oriented nose bridges;

FIG. 6 is a front perspective view of a sixth embodiment of the present invention comprising an eyeglass frame assembly having a pivoting nose bridge and a removable single left temple;

FIG. 7 is a perspective view of an interchangeable right temple for use in the eye-glass frame assembly of FIG. 6;

FIG. 8 is a perspective view of a seventh embodiment of the present invention comprising an eyeglass frame assembly having a temple and a nose bridge, the positions of which on opposite sides of the frame are interchangeable;

FIG. 9 is a perspective view of a temple for use in the eyeglass frame assembly of FIG. 8; and

FIG. 10 is an elevation view of the components of a kit for a monocular eyeglass assembly in accordance with one embodiment of the present invention.

### DETAILED DESCRIPTION OF THE INVENTION AND PREFERRED EMBODIMENTS THEREOF

The present invention provides an eyeglass frame assembly which permits a user to enjoy corrected vision in one eye while leaving the other eye and its surrounding area unobstructed to allow for the application of makeup, for the introduction of eye drops or other medication, for the removal of foreign objects, or for any other purpose for which access to the eye and its immediate surrounding area without the obstruction of an eyeglass lens or frame is needed. The assembly of this invention includes a frame portion for holding an eyeglass lens, a nose piece for resting the assembly on the bridge of the nose, and a temple with a curved ear piece for securing the assembly to the user's ear. No portion of the assembly extends beyond the nose bridge so that the user's “other eye”, i.e., the eye which does not have the lens aligned with it, and the area immediately surrounding the other eye are not shielded or covered by any part of the assembly. To allow the user to move the assembly from one eye to the other, various embodiments are provided in which duplicate, reversible, or replaceable nose pieces and/or temples and ear pieces are provided, all of which leave the eye with which the lens is not aligned and its immediate vicinity free and clear of any portion of the assembly. One aspect of the present invention is that the assembly may comprise a frame for a single lens (which may be a bifocal or trifocal lens or the like), a single temple attached thereto and, optionally, a single nose piece. This provides a contrast with prior art assemblies which have a frame configured to hold two lenses and which have dual temples, one for each side of the face, attached thereto.

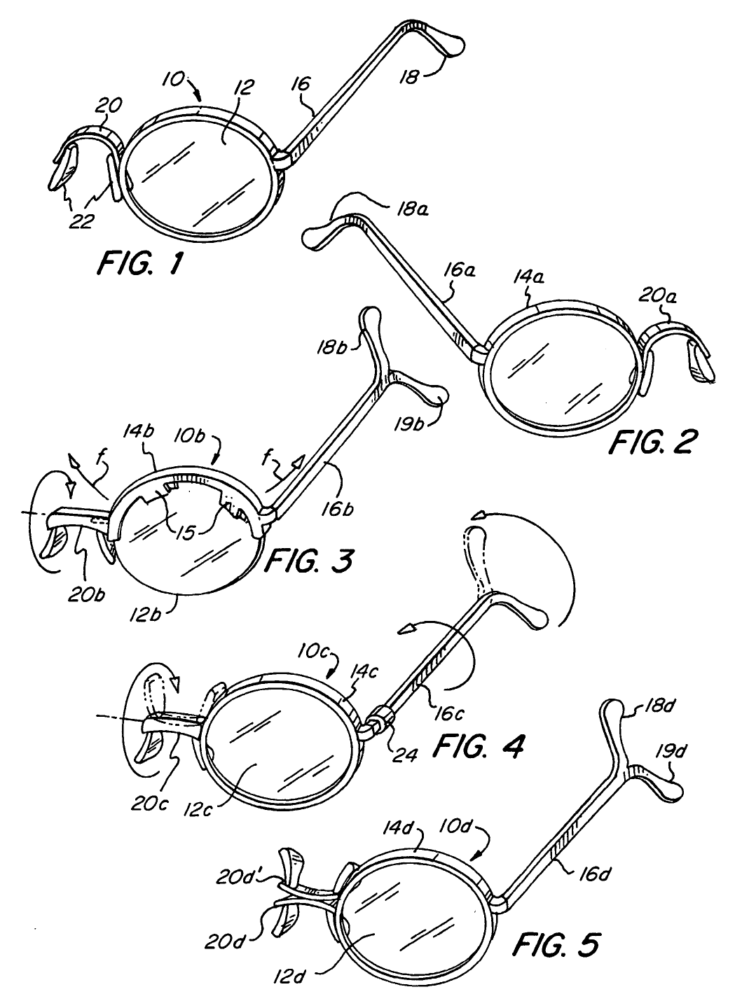

FIG. 1 shows a perspective view of an eyeglass frame assembly 10 according to one embodiment of the present invention. The assembly 10 includes a rim or frame 14 for an optical device, such as a lens 12 mounted within frame 14.

A single temple 16 is coupled to one side of the frame 14. The temple 16 ends in an ear piece 18 which is a curved portion or other configuration of the distal end of temple 16 which is suitable to seat temple 16 at the base of the wearer's ear, in the usual manner.

A nose bridge 20 is mounted on a side of the frame 14 opposite the temple 16, allowing the frame assembly 10 to rest on the wearer's nose on optional nose pads 22. The embodiment shown in FIG. 1 depicts the front view of a single temple 16 and nose bridge 20 coupled to the frame 14 in an orientation providing a left eyeglass frame assembly. As with the other embodiments of the present invention, the lens 12 may comprise any device suitable for aiding or correcting vision including, but not limited to, a magnifying lens, a simple prescription lens, a bifocal or trifocal prescription lens, or a combination thereof.

FIG. 2 shows a view of a frame assembly 10a comprising a single temple 16a and nose bridge 20a coupled to the frame 14a so as to provide a right eyeglass frame assembly.

FIG. 3 shows a front perspective view of another embodiment providing an eye-glass frame assembly 10b which can be used to position a lens 12b over either eye. In this embodiment, the frame assembly 10b includes a frame 14b and a single temple 16b coupled to one end of the frame 14b, the temple ending in a pair of oppositely curved ear pieces 18b, 19b. In an alternative embodiment, not shown, only one of curved ear pieces 18b, 19b need be provided, if it is pivotably attached to temple 16b or otherwise made detachable therefrom and replaceable thereon in either position corresponding to ear pieces 18b and 19b. A pivoting nose bridge 20b is pivotably mounted to the frame 14b opposite the temple 16b. During use, the wearer decides whether ear piece 18b or 19b will rest on the right or left ear, respectively, and pivots nose bridge 20b so that pads 22 point in the same direction as the selected ear piece. An alternative to the pivoting nose bridge 20b is a nose bridge configured so that either the top or the bottom thereof may rest upon the bridge of the wearer's nose. For example, a second pair of nose pads (not shown in FIG. 3) may be positioned on nose bridge 20b directed oppositely to pads 22 thereof, as illustrated in FIG. 5.

FIG. 3 illustrates a further aspect of the invention by showing frame 14b configured to releasably retain a lens 12b therein. That is accomplished in the illustrated embodiment by configuring frame 14b as a flexible half-frame. Frame 14b is configured so that when a properly fitted lens 12b is positioned therein, the ends of the frame close about the lens 12b and exert sufficient pressure about the opposite ends of the lens to retain it therein during use. However, frame 14b is sufficiently flexible to permit the user to flex it open as indicated by arrows f to remove lens 12b and replace it with another lens when assembly 10d is positioned for use with the user's other eye. This feature is useful in the event that the user's left and right eyes require respective different lenses. Alternatively, the frame 14d may be dimensioned and configured to permit the user to rotate or shift the lens when the assembly is moved from one eye to the other. Instead of, or in addition to, providing a flexible frame, the frame 14b may include any suitable structure, such as the illustrated lens clips 15, to releasably hold the lens onto the frame to permit release of the lens and replacement with another, as the user wishes. Obviously, any suitable means for removably retaining lens 12b in frame 14b may be used.

FIG. 4 shows a front perspective view of yet another embodiment of an eyeglass frame assembly 10c of this invention with a lens 12c therein. In the embodiment of FIG. 4, the frame 14c has a single temple 16c mounted thereon at one end and a pivoting nose bridge 20c pivotably mounted on the frame 14c opposite from temple 16c. Temple 16c is pivotably attached to frame 14c through pivot joint 24. The wearer selectively rotates the pivoting temple 16c and pivoting nose bridge 20c into place for wearing as a right eyeglass frame assembly or a left eyeglass frame assembly, as desired. Instead of providing a pivot point 24, the temple 16c may be made to be removed from frame 14c, pivoted or otherwise re-oriented, and then replaced in frame 14c. Generally, one or both of the temple and nose piece may be repositionable relative to the frame to convert the monocular eyeglass assembly of the present invention between a left-eye and a right-eye monocular eyeglass. As in all embodiments of the present invention, lens 12c may be removable so that a different lens may be substituted for the other eye, or lens 12c may be rotatable or shiftable to align different portions thereof with the user's eye, depending on which eye the lens 12c is aligned with.

FIG. 5 provides a front perspective view of yet another embodiment of the present eyeglass frame assembly 10d with a lens 12d mounted therein. In this embodiment, the assembly 10d includes a frame 14d having a single temple 16d ending in oppositely curved ear pieces 18d, 19d. Temple 16d is coupled to one end of the frame 14d and a pair of oppositely oriented nose bridges 20d, 20d′ are coupled to the end of the frame 14d opposite the temple 16d. During use, the wearer orients the eyeglass frame assembly 10d on the face to position the lens 12d over the right eye or the left eye as desired, with the temple 16d at the corresponding side of his or her face.

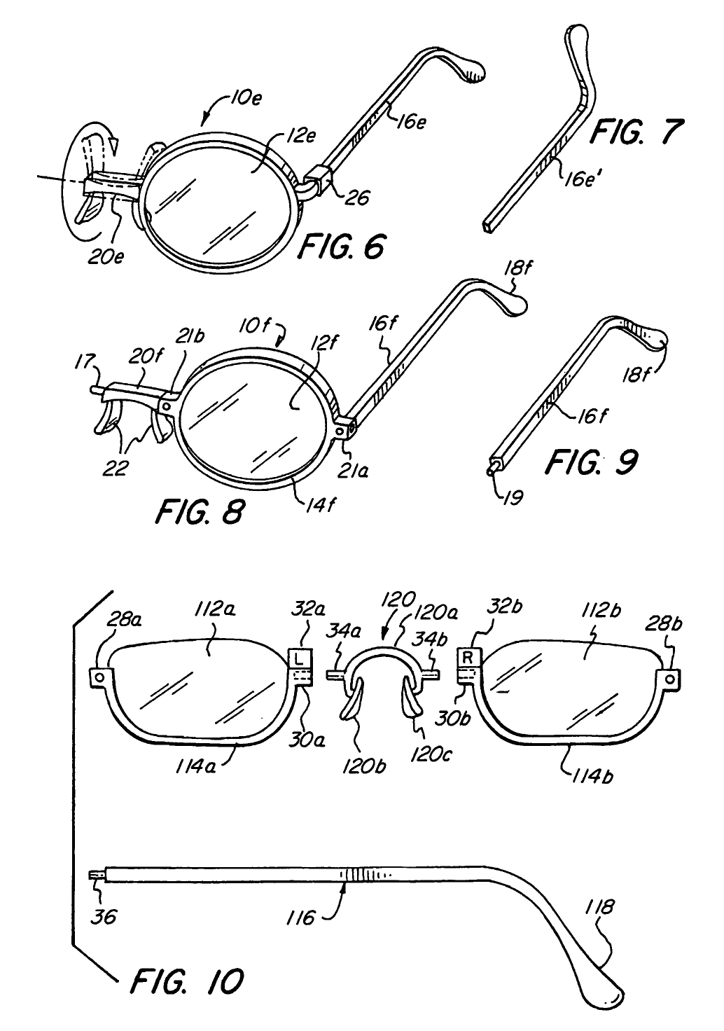

FIG. 6 provides a perspective view of yet another embodiment of an eyeglass frame assembly 10e with a lens 12e mounted thereon. Assembly 10e comprises non-pivoting temple 16eremovably mounted in a fitting 26. A nose bridge 20e is pivotably mounted on one end of the frame 14e opposite from temple 16e. Temple 16eis not pivotable, but it is removable from fitting 26, so that a temple 16e′ (FIG. 7) with an oppositely curved ear piece can be mounted in place of temple 16e. With temple 16e′ in place, nose bridge 20e can be rotated, as suggested by the rotation arrow, to configure assembly 10e for use on the other side of the wearer's face. Alternatively, nose piece 20e may be a double nose piece such as nose pieces 20d, 20d′ of FIG. 5.

FIG. 8 illustrates another embodiment of the present invention, in which a single frame 10f is provided with connector joints 21a, 21b at opposite sides of frame 14f. Nose bridge 20f has optional nose pads 22 thereon and a pair of opposite connectors, only one of which, connector 17, is visible in FIG. 8. The other connector 17 is inserted within a recess (not visible in FIG. 8) in connector joint 21b. Similarly, temple 16f, which has at its distal end a curved ear piece 18f, has at its opposite, proximal end a connector 19 (FIG. 9), which is received within a recess (not visible in FIG. 8) in connector joint 21a. Connectors 17 and 19 and the recesses in connector joints 21a and 21b are dimensioned and configured to snap-fit within, or otherwise to be removably connected to, connector joints 21a and 21b. Each of connector joints 21a, 21b has two recesses formed therein, one to receive connector 19 of temple 16fand the other to receive one of connectors 17 of nose piece 20f. With this construction, the positions of nose bridge 22f and temple 16fon frame 14f may be interchanged, thereby converting the assembly 10f between a left-eye assembly of the type illustrated in FIG. 1 and a right-eye assembly of the type illustrated in FIG. 2. As with all embodiments, lens 12f may be made removable from frame 14f, or rotatable therein, or otherwise re-positionable to enable changing lenses for the user's left and right eyes, if needed.

Referring now to FIG. 10, there is shown a kit for a monocular eyeglass assembly comprising two lenses 112a and 112b each having a half-frame 114a, 114b, respectively. Half-frame 114a has a temple connector fitting 28a and a nose bridge connector fitting 30a and a tab 32a bearing the letter L to serve as indicia that this lens is for the wearer's left eye. Similarly, half-frame 114b has a temple connector fitting 28b, a nose bridge connector fitting 30b and a tab 32b bearing the letter R to serve as indicia that this lens is for the wearer's right eye. Lenses 112a and 112b are shown in FIG. 10 as they would face the wearer when in use.

Nose bridge 120 is comprised of a curved bridge 120a and a pair of nose pads 120b and 120c. Side connector fittings 34a, 34b extend from opposite sides of nose bridge 120 and are dimensioned and configured to be connectable to, respectively, nose bridge connector fittings 30a, 30b and to be removable therefrom.

A temple 116 terminates in a curved ear piece 118 at its distal end and has an end fitting 36 at its proximal end. End fitting 36 is dimensioned and configured to be connectable to either of temple connector fittings 28a and 28b and to be removable therefrom.

In use, when the wearer wishes to minister to the right eye, end fitting 36 is inserted into temple connector fitting 28a of lens 112a and side connector fitting 34a is inserted into nose bridge connector fitting 30a of lens 112a. Nose bridge 120 of the resulting assembly is placed over the wearer's nose and ear piece 118 is placed behind the wearer's left ear. This places lens 112 in alignment with the wearer's left eye for correction of vision in that eye and leaves the wearer's right eye and its surrounding area completely unobstructed. When the wearer wishes to minister to the left eye, temple 116 and nose bridge 120 are removed from lens 112a, side connector fitting 34b is inserted into nose bridge connector fitting 32b and end fitting 36 is inserted into temple connector fitting 28b. Nose bridge 120 of the resulting assembly is placed over the wearer's nose and ear piece 118 is placed behind the wearer's right ear to place lens 112b in alignment with the wearer's right eye, leaving the left eye and its surrounding area unobstructed by the assembly. In other embodiments, a second temple (not shown) similar to temple 116 may be included in the kit if it is desired that ear piece 118 have a suitable left- or right-hand curve to more comfortably fit behind the wearer's ear.

Tabs 32a and 32b may be omitted, if the construction of temple connectors 28a and 28b are such that they will accept only end fitting 36 and the construction of nose bridge connector fittings 30a and 30b is such that they will accept only side connector fittings 34a, 34b. This feature is provided by the construction illustrated in FIG. 10, wherein the opening for temple connector fittings 28a, 28b face outwardly from the drawing and the openings for nose bridge connector fittings 30a, 30b lie within the plane of the drawing. The various connector fittings may be configured to provide any suitable way of connecting the lens, temple and nose bridge to each other to provide a stable assembly and then disconnecting them. The connector fittings may, for this purpose, bear complementary screw threads or may be bayonet-type connectors and receptacles.

Although the invention has been described in detail in connection with specific preferred embodiments thereof, it will be appreciated that variations thereto may be made which nonetheless lie within the spirit and scope of the claims. For one example, each lens of a kit may have a nose bridge permanently affixed to it. For another example, as described above in connection with, e.g., FIG. 1, a nose bridge and temple may be permanently affixed to a lens or to a lens frame to provide a monocular eyeglass assembly in a left-eye or right-eye configuration.

What is claimed is:

1. A monocular eyeglass assembly comprising:
only one lens, the lens having a temple side and a laterally opposite bridge side;
only one temple, the temple having a distal end and an opposite proximal end, the proximal end of the temple being attached to the lens at the temple side thereof; and
a nose bridge attached to the lens at the bridge side thereof;
the assembly being dimensioned and configured so that when the lens is disposed in alignment with one eye of the wearer, the wearer's other eye and its surrounding area are unobstructed by the assembly.

2. The assembly of claim 1 wherein the distal end of the temple is dimensioned and configured to be supported by either a wearer's left ear or right ear, thereby enabling the lens to be selectively positioned in alignment with either of the wearer's left eye or right eye, according to the ear on which the ear piece is supported.

3. The assembly of claim 2 wherein the distal end of the temple terminates in a pair of oppositely curved ear pieces, one of which is dimensioned and configured to be sup-ported on the wearer's left ear and the other of which is dimensioned and configured to be sup-ported on the wearer's right ear.

4. The assembly of claim 1, claim 2 or claim 3 further comprising a lens frame connecting the proximal end of the temple to the nose bridge and in which the lens is removably mounted, whereby to enable the wearer to replace one lens with another.

5. The assembly of claim 2 or claim 3 wherein the nose bridge has a top pad structure and an opposite-facing bottom pad structure, each of which is dimensioned and con-figured so as to rest upon the wearer's nose to support the bridge side of the lens.

6. The assembly of claim 2 or claim 3 wherein the nose bridge has a pad structure and is movable relative to the lens whereby the pad structure is selectively positionable to rest upon the wearer's nose when the ear piece is positioned to be supported on either the wearer's right ear or left ear.

7. A monocular eyeglass assembly comprising:
only one lens, the lens having a first side on which is disposed a first-side connector and a laterally opposite second side on which is disposed a second-side connector;
only one temple, the temple having a distal end and an opposite proximal end, the proximal end having a temple connector thereon; and
a nose bridge attached to the lens at the bridge side thereof, the nose bridge having at least one bridge connector thereon;
the connectors all being dimensioned and configured whereby both the proximal end of the temple and the nose bridge may be connected to either the first-side connector or the second-side connector of the lens, thereby configuring the assembly to selectively place the lens in alignment with either a wearer's left eye or right eye, the assembly being dimensioned and con-figured so that when the lens is disposed in alignment with one eye of the wearer, the wearer's other eye and its surrounding area are unobstructed by the assembly.

8. The assembly of claim 7 wherein the nose bridge has a pair of laterally opposite bridge connectors, one of which is dimensioned and configured to connect the nose bridge to the first-side connector and the other of which is dimensioned and configured to connect the nose bridge to the second-side connector.

9. A kit for a monocular eyeglass assembly comprising:
a plurality of lenses each having a temple side and a laterally opposite bridge side, a temple connector at the temple side and a bridge connector at the bridge side;
at least one temple having a distal end and an opposite proximal end and a temple connector at the proximal end; and
at least one nose bridge having at least one nose connector thereon;
wherein the connectors are dimensioned and configured to enable the temple and the nose bridge to be connected to a selected one of each of the plurality of lenses to provide an assembly which is dimensioned and configured to enable at least one of the lenses to be aligned with a wearer's left eye and at least another of the lenses to be aligned with a wearer's right eye, the assembly being dimensioned and configured so that when the lens is disposed in alignment with one eye of the wearer, the wearer's other eye and its surrounding area are unobstructed by the assembly.

10. The kit of claim 9 wherein the nose bridge has a pair of laterally opposite connectors, one of which is dimensioned and configured to connect the nose bridge to the bridge connector of at least one of the plurality of lenses and the other of which is dimensioned and configured to connect the nose bridge to the bridge connector of at least another one of the plurality of lenses.

11. A kit for a monocular eyeglass assembly comprising:
a plurality of lenses each having a temple side and a laterally opposite bridge side, a temple connector at the temple side and a nose bridge mounted at the bridge side, at least one of the plurality of lens being dimensioned and configured to comprise a right eye lens and at least another of the plurality of lenses being dimensioned and configured to comprise a left-eye lens;
at least one temple having a distal end and an opposite proximal end and a temple connector at the proximal end;
wherein the connectors are dimensioned and configured to enable the temple to be connected to a selected one of each of the plurality of lenses at the temple side thereof to provide an assembly which is dimensioned and configured to enable at least one of the lenses to be aligned with a wearer's left eye and at least another of the lenses to be aligned with a wearer's right eye, depending on whether the lens is a right-eye lens or a left-eye lens, the assembly being dimensioned and configured so that when the lens is disposed in alignment with one eye of the wearer, the wearer's other eye and its surrounding area are unobstructed by the assembly.

12. The kit of claim 9, claim 10 or claim 11 wherein the plurality of lenses comprises at least one lens having optical characteristics suitable for a wearer's left eye and at least one lens having optical characteristics suitable for the wearer's right eye.

13. The kit of claim 12 wherein the lenses bear indicia to signify whether they are for a wearer's left eye or right eye.

14. The kit of claim 9, claim 10 or claim 11 comprising two lenses.
